(19) United States
(12) Patent Application Publication
(10) Pub. No.: US 2007/0215274 A1
(43) Pub. Date: Sep. 20, 2007

(54) Process for the Manufacturing of a Thermosetting Laminate

(75) Inventors: Christina Eriksson, Trelleborg (SE); Hans Persson, Perstorp (SE)

Correspondence Address: STEVENS DAVIS MILLER & MOSHER, LLP, 1615 L STREET, NW, SUITE 850, WASHINGTON, DC, 20036, US

(73) Assignee: Pergo (Europe) AB, Trelleborg (SE)

(21) Appl. No.: 11/596,256

(22) PCT Filed: May 16, 2005
(86) PCT No.: PCT/SE05/00697

§ 371 Date: Jan. 4, 2007

(30) Foreign Application Priority Data
May 26, 2004 (SE) 0401341.3

(51) Int. Cl. B32B 27/04

(52) U.S. Cl. 156/307.4

(57) ABSTRACT

A process for the manufacturing of a decorative laminate. The laminate comprises an upper decorative and abrasion resistant thermosetting laminate layer and a carrying core. The upper side of the core is provided with the abrasion resistant thermosetting laminate which is joined with the carrying core by means of a glue system comprising 8-25% by weight of particles calculated on the dry glue system.

The present invention relates to a process for the manufacturing of a decorative thermosetting laminate with a conducting layer intended to decrease effects of static charging.

Products coated with thermosetting laminate are common nowadays. They are foremost used where the demands on abrasion resistance are great, but also where resistance towards different chemicals and moisture are demanded. As example of such products can be mentioned floors, floor beadings, work tops, desk tops and wall panels.

The thermosetting laminate most often consists of a number of base sheets with decor sheet arranged closest to the surface. The decor sheet can be provided with a desired decor or pattern. Such laminates are very hard in order to withstand the wear they are exposed to. As all plastic materials, the thermosetting material described does not conduct electricity. It is also known that such laminates may cause electrical charges when for example rubbed under unfavourable conditions. A person walking on for example a floor containing thermosetting laminate may then be charged and unpleasantly discharged when touching a grounded object like a door handle. This sudden discharge may besides being unpleasant also be hazardous to people with hart conditions. It is furthermore known that sensitive electronic equipment can be damaged by this type of electrostatic discharge. It is highly desirable to be able minimise this static build up.

It has, through the present invention, been made possible to meet the above mentioned desires and a thermosetting laminate with a lower level of electrostatic charge generation has been achieved. Accordingly, the invention relates to a process for the manufacturing of a decorative laminate. The laminate comprises an upper decorative and abrasion resistant thermosetting laminate layer and a carrying core. The invention is characterised in that the upper side of the core is provided with the abrasion resistant thermosetting laminate which is joined with the carrying core by means of a glue system comprising 2-25% by weight of conducting particles calculated on the dry glue system. Said particles are selected from the group consisting of; carbon black, carbon fibre and a mixture thereof.

According to one embodiment of the invention the glue system further comprises urea formaldehyde glue and a curing agent. The curing agent suitably comprises ammonium chloride, urea, water and an inert filler.

According to one embodiment of the invention the thermosetting laminate is constituted by one or more decor papers, at least one overlay sheet arranged on top of the decor paper and optionally one or more conventional underlay papers arranged under the decor paper. At lest one of the sheets or papers are impregnated with thermosetting resin whereupon the sheets and papers are laminated together under increased pressure and increased temperature. At least one overlay sheet is suitably impregnated with thermosetting resin. The thermosetting resin used for impregnating the overlay sheet is suitably melamine formaldehyde resin. Also the optional conventional underlay papers are, when used, impregnated with thermosetting resin which suitably is selected from the group consisting of phenol-formaldehyde resin, melamine formaldehyde resin and urea formaldehyde resin.

At least one of the sheets impregnated with thermosetting resin, preferably the outermost, is suitably provided with hard particles of for example silicon oxide, aluminum oxide and/or silicon carbide with an average size of 1-100 μm, preferably around 5-60 μm. The thermosetting laminate suitably has a thickness in the range 0.3 mm-1.2 mm, preferably 0.3 mm-0.9 mm.

The carrying core may according to different embodiments of the invention be constituted of particle board, fibre board, oriented strand board, fibre cement board or a board based on polymers such as polyurethane. A polymer based board may further comprise fibres or particles.

The purpose of adding the conductive material is to reduce the risk for build-up of static charges. A number of tests have been performed in order to evaluate the results in these tests 100 parts per weight of urea formaldehyde glue and 12 parts per weight of curing agent, calculated on wet and ready to use components, were mixed with 2, 5, 10, 15 and 20 parts per weight of carbon black. A sample with no carbon black were also produced. The samples, with different amounts of carbon black were then tested by rubbing the surface of the samples with different materials known to produce static electricity. It was shown during test that the samples having between 10 and 15 parts per weight seemed to be optimal even though higher levels of carbon black further decreased the electrostatic charges to some point. The static charge were reduced to about ⅓ for optimal ranges above as compared to the sample having no carbon black. Some tests even showed a reduction of the static charge to 1/10 of the levels achieved by the sample having no carbon black.

The present invention may suitably be used for manufacturing floor panels which includes a core covered with an upper decorative surface. The core most often consists of wood particles or fibre bonded together with glue or resin. The laminate is most often produced in large formats which are cut into smaller formats after the lamination. The panels achieved are also provided with means for joining at the edges. Since the core material is sensitive to moisture it may be advantageous to treat the area closest to the joint if the floor is to be exposed to moisture. This treatment may suitably include resin, wax or some kind of lacquer. It will not be necessary to treat the joint if the floor panels are to be glued since the glue itself will protect the joint from moisture penetration. This treatment of the edge may also comprise conducting material like for example carbon black. The decorative upper surface consists of a decorative paper which may be pre-impregnated with melamine-formaldehyde resin. One or more layers of so called overlay paper of cellulose, impregnated with melamine-formaldehyde resin is suitably placed on top of the decorative paper. One or more of the above layers may be sprinkled with hard particles, of for example aluminum oxide, silicon carbide or silicon oxide in connection to the impregnation in order to improve the abrasion resistance. The paper impregnated with resin is cured before, or in connection to applying it to the core. The paper layers are suitably laminated together before they are applied to the core in cases where the upper decorative surface is constituted by more than one paper layers. The lower side may suitably be coated with a lacquer or a resin impregnated paper.

1. A process for the manufacturing of a decorative laminate, which laminate comprises an upper decorative and abrasion resistant thermosetting laminate layer and a carrying core, wherein the upper side of the core is provided with the abrasion resistant thermosetting laminate, that the abrasion resistant thermosetting laminate is joined with the carrying core by means of a glue system comprising 2-25% by weight of conducting particles calculated on the dry glue system.

2. A process according to claim 1, wherein said particles are selected from the group consisting of carbon black, carbon fibre and a mixture thereof.

3. A process according to claim 1, wherein the glue system further comprises urea formaldehyde glue and a curing agent.

4. A process according to claim 2, wherein the curing agent comprises ammonium chloride, urea, water and an inert filler.

5. A process according to claim 1, wherein the thermosetting laminate is constituted by one or more decor papers, at least one overlay sheet arranged on top of the decor paper and optionally one or more conventional underlay papers arranged under the decor paper, that at least one of the sheets or papers are impregnated with thermosetting resin whereupon the sheets and papers are laminated together under increased pressure and increased temperature.

6. A process according to claim 4, wherein the at least one overlay sheet is impregnated with thermosetting resin.

7. A process according to claim 5, wherein the thermosetting resin is a melamine formaldehyde resin.

8. A process according to claim 4, wherein the optional conventional underlay papers are impregnated with thermosetting resin.

9. A process according to claim 7, wherein the thermosetting resin is selected from the group consisting of phenol-formaldehyde, melamine formaldehyde resin and urea formaldehyde resin.

10. A process according to claim 1, wherein the carrying core is constituted by a particle board.

11. A process according to claim 1, wherein the carrying core is constituted by a fibre board.

12. A process according to claim 1, wherein the carrying core is constituted by an oriented strand board.

13. A process according to claim 1, wherein the carrying core is constituted by a board based on polymers such as polyurethane.

14. A process according to claim 1, wherein the carrying core is constituted by a fibre cement board.

15. A process according to claim 12, wherein the board further comprises fibre.

16. A process according to claim 12, wherein the board further comprises particles.

17. A process according to claim 4, wherein at least one of the sheets impregnated with thermosetting resin, preferably the outermost, is provided with hard particles of for example silicon oxide, aluminum oxide and/or silicon carbide with an average size of 1-100 μm, preferably around 5-60 μm.

18. A process according to claim 1, wherein the thermosetting laminate has a thickness in the range 0.3 mm-1.2 mm, preferably 0.3 mm-0.9 mm.
